(19) United States
(12) Patent Application Publication
(10) Pub. No.: US 2026/0155398 A1
(43) Pub. Date: Jun. 4, 2026

(54) Thermogalvanic Cell

(71) Applicants: IUCF-HYU (Industry-University Cooperation Foundation Hanyang University), Seoul (KR); Korea University Research and Business Foundation, Seoul (KR)

(72) Inventors: Kihoon Ryu, Seoul (KR); Eunho Choi, Seoul (KR); Yundong Lee, Seoul (KR); Wonjoon Choi, Seoul (KR); Sangtae Kim, Seoul (KR)

(21) Appl. No.: 18/963,770

(22) Filed: Nov. 29, 2024

(51) Int. Cl. H01M 6/36; H01M 4/02; H01M 4/06; H01M 6/16; H01M 50/437; H01M 50/491

(52) U.S. Cl. CPC H01M 6/36; H01M 4/06; H01M 6/164; H01M 50/437; H01M 50/491; H01M 2004/021

(57) ABSTRACT

A thermogalvanic cell is disclosed. In an embodiment, provided is a thermogalvanic cell including a first electrode; a second electrode; and an electrolyte between the first electrode and the second electrode; wherein the first electrode and the second electrode, identically or differently, include an alloy represented by Chemical Formula 1; power output is generated by an electrochemical reaction due to a temperature difference between the first electrode and the second electrode:

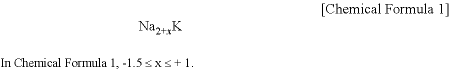

### FIELD OF THE INVENTION

A thermogalvanic cell is disclosed.

### DESCRIPTION OF THE RELATED ART

A thermogalvanic cell (TG cell) is a device that applies an electrochemical reaction depending on temperature.

As shown in FIG. 1, the thermogalvanic cell is generally composed of a low-temperature electrode, a high-temperature electrode, and an electrolyte, and is a cell that produces electricity through an electrochemical reaction that occurs when a temperature difference exists between the two electrodes.

In the above thermogalvanic cell, a discharge voltage (ΔV) is determined by the chemical potential difference between the two electrodes as expressed in Equation 1, while the thermal conductivity (κ) and ionic conductivity (o) are determined by the electrolyte.

$$Δ v = - \frac{1}{e} ( {μ}_{M}^{hot} - {μ}_{M}^{cold} ) \qquad [ Equation 1 ]$$

In Equation 1, e is a charge amount of an electron; μ_{M}^{hot} is a chemical potential of the high-temperature electrode; and μ_{M}^{cold} is a chemical potential of the low-temperature electrode.

Meanwhile, the efficiency (ZT) of the thermogalvanic cell is proportional to the thermopower (α) and ion conductivity (σ), and inversely proportional to the thermal conductivity (κ), as shown in Equation 2.

$$ZT = \frac{{α}^{2} σ T}{κ} \qquad [ Equation 2 ]$$

In Equation 2, a is a thermopower of the thermogalvanic cell; σ is an ionic conductivity of the electrolyte included in the thermogalvanic cell; T is an operating temperature of the cell; and K is a thermal conductivity of the electrolyte included in the thermogalvanic cell.

According to Equation 2, in order to increase the efficiency (ZT) of the thermogalvanic cell, it is necessary to study an electrode material that exhibits high thermopower (α).

Up to now, electrode materials such as TE (Bi₂Te₃, α=0.2 mV/K), TG-Solid (LiCoO₂, α=1.2 mV/K), and TG-Liquid (Fe(CN)₆^{3-/4-}, α=4.2 mV/K) have been studied. However, for commercialization of thermogalvanic cells, electrode materials that exhibit a groundbreaking thermopower (α) exceeding 4.2 mV/K are required.

### SUMMARY OF THE INVENTION

### a. Problem to be Solved

An embodiment provides a thermogalvanic cell using a Na₂₊ₓK-based alloy as a material capable of exhibiting remarkably high thermopower (α).

### b. Solution

In an embodiment, a thermogalvanic cell includes: a first electrode; a second electrode; and an electrolyte between the first electrode and the second electrode; wherein the first electrode and the second electrode, identically or differently, include an alloy represented by Chemical Formula 1; and power output is generated by an electrochemical reaction due to a temperature difference between the first electrode and the second electrode:

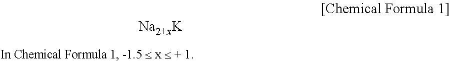

### c. Advantage of the Solution

The Na₂₊ₓK-based alloy is a material that can exhibit remarkably high thermopower (α) in the solid-liquid phase transition region.

Therefore, the novel thermogalvanic cell of an embodiment, while having a structure similar to that of a conventional thermogalvanic cell, can exhibit significantly higher power and efficiency (ZT) than that of a conventional thermogalvanic cell by applying an electrode material capable of exhibiting significantly higher thermopower (α) and power in the solid-liquid phase transition region.

### BRIEF DESCRIPTION OF THE DRAWINGS

FIG. 1 schematically illustrates a structure and operating principle of a generally known thermogalvanic cell.

FIG. 2 schematically illustrates a structure of a novel thermogalvanic cell according to an embodiment and an electrochemical reaction in the structure.

FIG. 3 is a graph showing a change in entropy in the region where a specific material changes phase from solid to liquid.

FIG. 4 is a graph of the solid-liquid phase transition according to the change in the K content in the alloy of Na and K.

FIG. 5 is a graph showing the thermopower (α) according to temperature change of pure Na metal, an alloy of Na and K, etc.

FIG. 6 shows the results of evaluating the electrochemical characteristics of the thermogalvanic cell of Example 1.

FIGS. 7 and 8 show the results of evaluating the electrochemical characteristics of the thermogalvanic cell of Example 2, respectively.

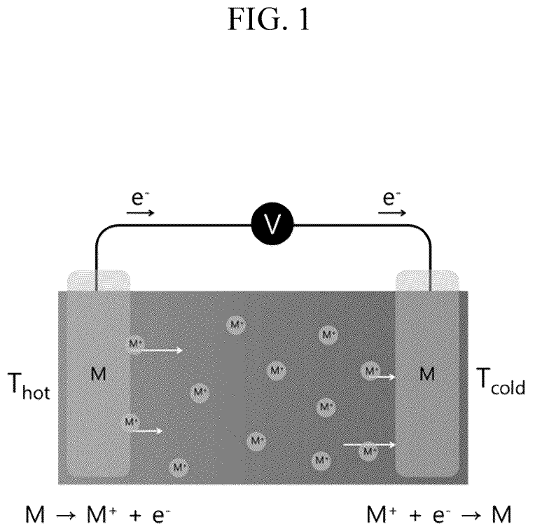

### DETAILED DESCRIPTION OF THE EMBODIMENTS

Hereinafter, specific embodiments will be described in detail so that those of ordinary skill in the art can easily implement them. However, this disclosure may be embodied in many different forms and is not construed as limited to the example embodiments set forth herein.

### DEFINITION OF TERMS

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” herein includes not only a shape formed on the whole surface when viewed from a plan view, but also a shape formed on a partial surface.

“Thickness” may be measured, for example, from photographs taken with an optical microscope such as a scanning electron microscope.

### (Thermogalvanic Cell)

An embodiment provides a novel thermogalvanic cell.

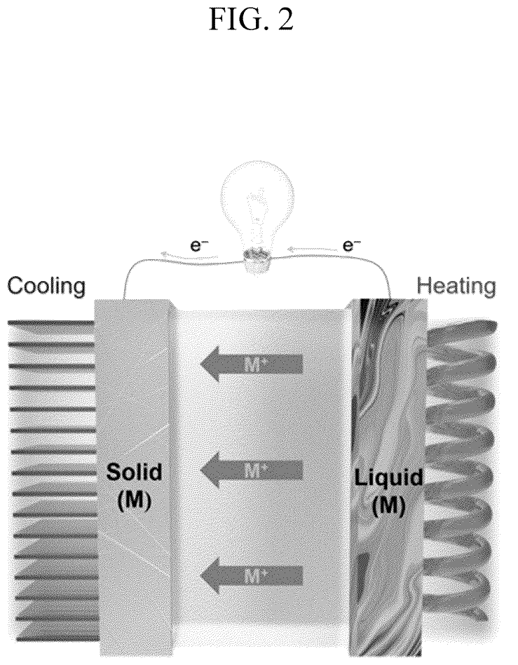

FIG. 2 schematically illustrates the structure of a novel thermogalvanic cell according to an embodiment and the principle by which an electrochemical reaction, particularly a discharge, occurs in the structure.

(1) A novel thermogalvanic cell of an embodiment, like a conventional thermogalvanic cell, includes a first electrode, a second electrode, and an electrolyte between the first electrode and the second electrode; and applies an electrochemical reaction caused by a temperature difference between the first electrode and the second electrode.

Here, a voltage difference is induced in a state where the second electrode has a relatively higher temperature than the first electrode, so that power of the thermogalvanic cell can be generated. In this sense, the first electrode may be a ‘low-temperature electrode’ and the second electrode may be a ‘high-temperature electrode.’

(2) However, the novel thermogalvanic cell of the above embodiment applies a Na₂₊ₓK-based alloy, which is a material capable of exhibiting remarkably high thermopower (α) in the solid-liquid phase transition region, to each of the first electrode (low-temperature electrode) and the second electrode (high-temperature electrode).

Specifically, the thermopower (α) of the thermogalvanic cell is proportional to the change in entropy, as can be seen in Equation 3.

$$α ∝ \frac{d Δμ}{dT} = {( \frac{\partial Δ S}{\partial N} )}_{P} \qquad [ Equation 3 ]$$

In Equation 3, a is a thermopower of the thermogalvanic cell; u is a chemical potential of the cell electrode; T is a temperature of the cell; S is the entropy of the electrode; and N is the number of particles in the electrode.

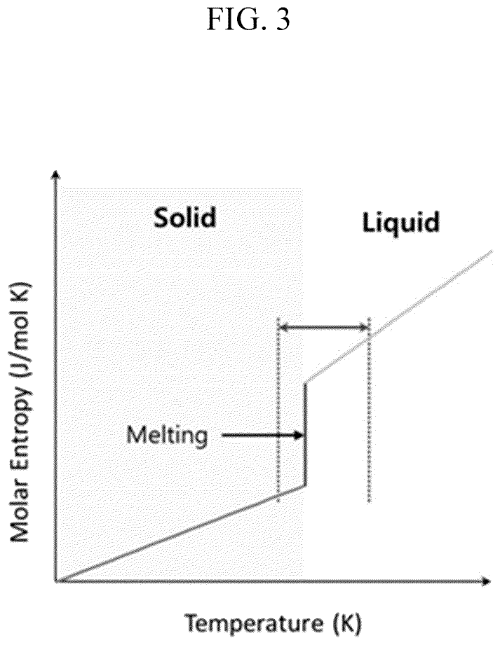

However, FIG. 3 is a graph showing the change in entropy in the region where a specific substance changes from a solid to a liquid. As shown in FIG. 3, the entropy increases rapidly in the region where the phase changes from solid to liquid (hereinafter referred to as the ‘solid-liquid phase transition’).

(3) In summary, the novel thermogalvanic cell of an embodiment has a structure similar to that of a conventional thermogalvanic cell, but by applying an electrode material capable of exhibiting significantly higher thermopower (α) and power in the solid-liquid phase transition region, it can exhibit significantly higher power and efficiency (ZT) than the conventional thermogalvanic cell.

Hereinafter, a novel thermogalvanic cell according to an embodiment is described in more detail.

### Na₂₊ₓK-Based Alloy

A novel thermogalvanic cell of an embodiment, wherein the first electrode and the second electrode, identically or differently, include an alloy represented by Chemical Formula 1 is provided:

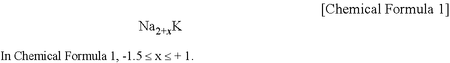

The alloy represented by Chemical Formula 1 can exhibit a thermopower (α) exceeding at least 4.2 mV/K and up to 26 mV/K in the solid-liquid phase transition region.

Therefore, the novel thermogalvanic cell of an embodiment can exhibit higher efficiency (ZT) compared to conventional thermogalvanic cells.

### Operating Principles and Temperature of Thermogalvanic Cell

The novel thermogalvanic cell of the above embodiment applies a Na₂₊ₓK-based alloy to each of the first electrode (low-temperature electrode) and the second electrode (high-temperature electrode), and can cause an electrochemical reaction (specifically, discharge) to occur due to the temperature difference between the first electrode and the second electrode. Here, the first electrode can function as a ‘low-temperature electrode’ and a “positive electrode’, and the second electrode can function as a ‘high-temperature electrode’ and a “negative electrode.’

Specifically, the first electrode (low-temperature electrode) may be maintained within a temperature range of less than 7° C., less than or equal to 6° C., less than or equal to 5° C., or less than or equal to 4° C., but greater than or equal to 0° C. Meanwhile, the second electrode (high-temperature electrode) may be varied starting from a range of less than or equal to 8° C., less than or equal to 6° C., or less than or equal to 4° C. but greater than or equal to 0° C., to a range of less than or equal to 15° C., less than or equal to 14° C., less than or equal to 13° C., less than or equal to 12° C., less than or equal to 11° C., or less than or equal to 10° C. but greater than or equal to 8° C., or greater than or equal to 9° C.

For example, if the temperature of the first electrode (low-temperature electrode) is maintained at 4° C., but the temperature of the second electrode (high-temperature electrode) is changed from 8° C. to 12° C., a high thermopower (α) of up to about 10 mV/K can be obtained. For another example, when the temperature of the first electrode (low-temperature electrode) is maintained at 4° C., but the temperature of the second electrode (high-temperature electrode) is varied from 4° C. to 14° C., a remarkably high thermopower (α) of 17 to 26 mV/K can be obtained.

In any of the above cases, a high thermopower (α) can be obtained compared to conventional materials such as TE (Bi₂Te₃, α=0.2 mV/K), TG-Solid (LiCoO₂, α=1.2 mV/K), and TG-Liquid (Fe(CN)₆^{3-/4-}, α=4.2 mV/K).

Here, in order to obtain a remarkably high thermopower (α) of 17 to 26 mV/K, it is advantageous to ‘maintain the first electrode (low-temperature electrode) in a solid state’ while ‘only the second electrode (high-temperature electrode) undergoes a solid-liquid phase transition’ to induce ‘a temperature difference between the first electrode and the second electrode’.

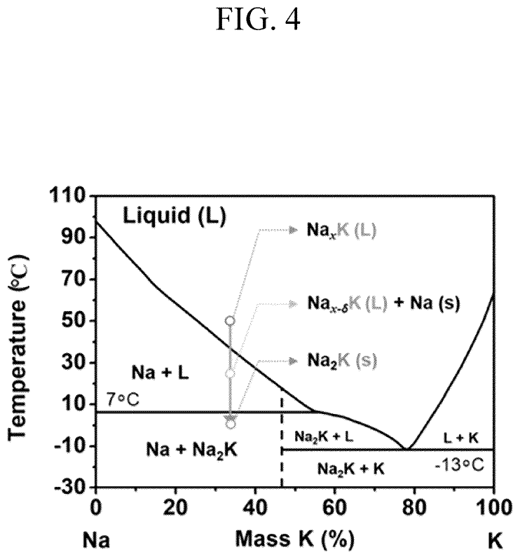

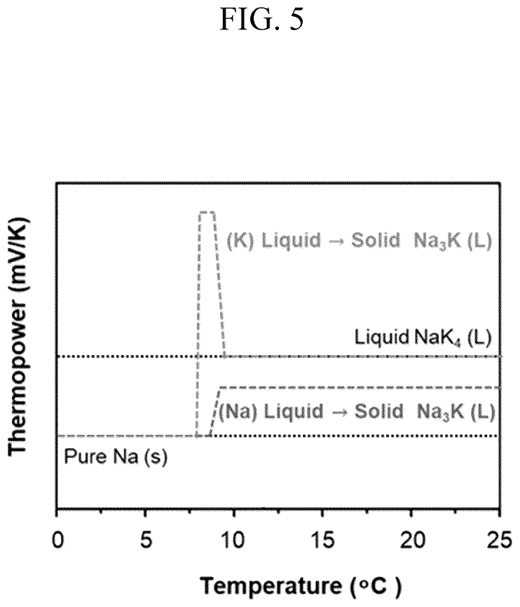

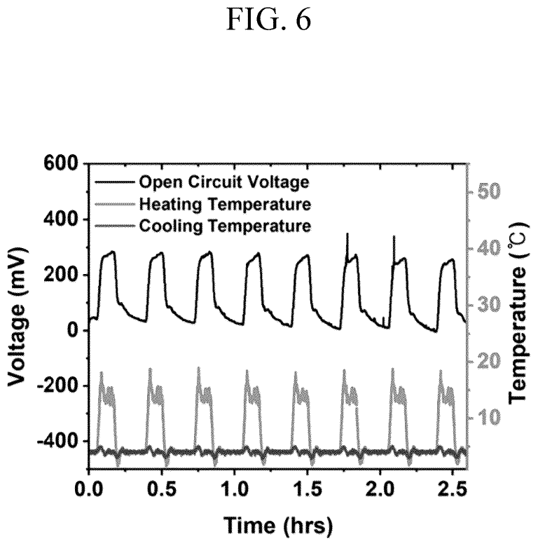

FIG. 4 is a graph of the solid-liquid phase transition according to the change in the K content in the alloy of Na and K. In addition, FIG. 5 is a graph showing the thermopower (α) according to temperature change of pure Na metal, an alloy of Na and K, etc.

In particular, since the melting point of the Na₂₊ₓK-based alloy is about 7° C., it is desirable that the first electrode be maintained in a temperature range below the melting point of the Na₂₊ₓK-based alloy (e.g., 4° C.), and the second electrode be changed from a temperature range below the melting point of the Na₂₊ₓK-based alloy to a temperature range above the melting point (e.g., from 4° C. to 14° C.).

### Electrolyte

In a novel thermogalvanic cell of an embodiment, the electrolyte may include a potassium salt and a non-aqueous organic solvent.

Specifically, the potassium salt may be at least one selected from a first potassium salt including K(FSO₂)₂N(KFSI), K(CF₃SO₂)₂N(KTFSI), KPF₆, KBF₄, KClO₄, KCF₃SO₃, KC₄F₉SO₃, KAsF₆, and KN(C₂F₅SO₂)₂ (KBETI).

The non-aqueous organic solvent may be at least one selected from a glyme solvent including ethylene glycol dimethyl ether (CH₃OCH₂CH₂OCH₃: monoglyme) and diethylene glycol dimethyl ether (CH₃ (OCH₂CH₂)₂OCH₃: diglyme); and a carbonate solvent including dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC).

The glyme solvent has higher thermal conductivity (κ) and ionic conductivity (σ) than the carbonate solvent.

Meanwhile, for the stability of the electrolyte, TTE (1,1,2,2-tetrafluoroethyl-2,2,3,3-tetrafluoropropyl ether), C₃H₂O₃ (vinylene carbonate), C₃H₃FO₃ (fluoroethylene carbonate), or a combination thereof may be added as an additive.

The additive may be included in an amount of 0.1 to 10 wt %, 1 to 8 wt %, or 3 to 7 wt %, based on 100 wt % of the total amount of the electrolyte. The stability of the electrolyte can be efficiently improved within this range.

### Structure of Thermogalvanic Cell

In a novel thermogalvanic cell of an embodiment, since the second electrode (high-temperature electrode) is an electrode that undergoes a phase transition from a solid to a liquid, the second electrode (high-temperature electrode) may be confined inside a porous substrate to suppress a change in the shape of the second electrode (high-temperature electrode).

The second electrode further includes a porous substrate, and the alloy represented by Chemical Formula 1 may be impregnated inside the porous substrate.

The porous substrate may be a conductive material. Specifically, the porous substrate may be at least one selected from a metal foam including copper foam; and a porous carbon material including carbon paper, carbon cloth, and carbon felt. For example, the porous substrate may be a copper (Cu) foam.

The novel thermogalvanic cell of an embodiment further includes a separator, and the electrolyte may be impregnated inside the separator. Since the electrolyte is a liquid, the liquid electrolyte may be confined inside a porous separator to suppress shape change of the liquid electrolyte.

The separator may be a glass filter, a porous polymer film, or an ion exchange film.

In a novel thermogalvanic cell of an embodiment, a thickness ratio of the first electrode and the second electrode may be 1:2 to 2:1. Additionally, the thickness ratio of the first electrode and the electrolyte may be 1:1 to 250:1.

A total thickness of the thermogalvanic cell may be 0.1 to 5 cm.

Within this range, the output of the novel thermogalvanic cell of an embodiment may be optimized.

In an embodiment of the novel thermogalvanic cell, a cooling source may be disposed outside the first electrode; and a heat source may be disposed outside the second electrode.

Hereinafter, examples and comparative examples of the present invention are described. The following examples are only examples of the present invention, and the present invention is not limited to the following examples.

### EXAMPLES

### Example 1: Thermogalvanic Cell with Symmetrical Structure of Na₂K (First Electrode)|KPF₆ in DEGDME+TTE (Electrolyte)|Na₂K (Second Electrode)

### (1) Manufacturing of First Electrode (Low-Temperature Electrode)

In a glove box with an environment where the concentrations of O₂ and H₂O are less than 0.1 ppm, Na and K metals are cut according to the Na—K alloy ratio, placed in a vial, and heated sufficiently to above 40° C. to form a uniform alloy (Na₂K). When the formed alloy is heated to a temperature of over 300° C. and an electrode such as copper foam is placed into the alloy, the alloy is impregnated into the electrode. The impregnated electrode is cooled to room temperature to manufacture the electrode.

### (2) Manufacturing of Second Electrode (High-Temperature Electrode)

The electrode is manufactured in the same manner as the first electrode.

### (3) Manufacturing of Electrolyte

KPF₆ at a concentration of 1 M was used as the first potassium salt, and diethylene glycol dimethylether (CH₃(OCH₂CH₂)₂OCH₃: diglyme) as a glyme-based solvent and TTE (1,1,2,2-tetrafluoroethyl-2,2,3,3-tetrafluoropropyl ether) as an additive were added thereto to prepare an electrolyte. Herein, the additive was designed to be included in an amount of 5 wt % based on 100 wt % of a total amount of the electrolyte.

### (4) Assembly of Thermogalvanic Cell

After laminating the first electrode (low-temperature electrode), the second electrode (high-temperature electrode), and the electrolyte and elementalizing the laminate in the form of a coin cell and then, disposing a cooling source outside the first electrode (low-temperature electrode), while a heating source was disposed outside the second electrode (high-temperature electrode), a thermocouple temperature measuring apparatus was finally attached thereto to complete a thermogalvanic cell.

### Example 2: Thermogalvanic Cell with Symmetrical Structure of Na₂K (First Electrode)|KFSI+KNO₃ in DEGDME (Electrolyte)|Na₂K (Second Electrode)

A thermogalvanic cell of Example 2 was completed by changing the electrolyte of Example 1 to 0.5 M KFSI+KNO₃ in DEGDME.

### Example 3: Thermogalvanic Cell with Symmetrical Structure of Na₂K (First Electrode)|KFSI in DEGDME (Electrolyte)|Na₂K (Second Electrode)

A thermogalvanic cell of Example 3 was completed by changing the electrolyte of Example 1 to 0.5 M KFSI in DEGDME.

### Example 4: Thermogalvanic Cell with Symmetrical Structure of Na₂K (First Electrode)|KPF₆ in EC+DEC (Electrolyte)|Na₂K (Second Electrode)

A thermogalvanic cell of Example 4 was completed by changing the electrolyte of Example 1 to 0.5 M KPF₆ in EC:DEC=1:1 (v:v).

### COMPARATIVE EXAMPLE

### Comparative Example 1: Thermogalvanic Cell with Asymmetric Structure of Na (First Electrode)|NaClO₄ in EC+DEC (Electrolyte)|Na (Second Electrode)

A thermogalvanic cell of Comparative Example 1 was completed by changing the composition of the first electrode (low-temperature electrode) and the second electrode (high-temperature electrode) to Na and also, changing the electrolyte of Example 1 to 0.5 M NaClO₄ in EC:DEC=1:1 (v:v).

### Comparative Example 2: Thermogalvanic Cell with Asymmetric Structure of K (First Electrode)|KPF₆ in EC+DEC (Electrolyte)|K (Second Electrode)

A thermogalvanic cell of Comparative Example 2 was completed by changing the composition of the first electrode (low-temperature electrode) and the second electrode (high-temperature electrode) to Na and also, changing the electrolyte of Example 1 to 0.5 M KPF₆ in EC:DEC=1:1 (v:v).

### Comparative Example 3: Thermogalvanic Cell with Asymmetric Structure of Na_{0.7}K_{0.3} (First Electrode)|NaClO₄ in EC+DEC (Electrolyte)|Na_{0.7}K_{0.3} (Second Electrode)

A thermogalvanic cell of Comparative Example 3 was completed by changing the composition of the first electrode (low-temperature electrode) and the second electrode (high-temperature electrode) to Na_{0.7}K_{0.3} and also, changing the electrolyte of Example 1 to 1 M NaClO₄ in EC:DEC=3:7 (v:v).

### Comparative Example 4: Thermogalvanic Cell with Symmetrical Structure of Pt (First Electrode)|NaClO₄ in EC+DEC (Electrolyte)|Pt (Second Electrode)

A thermogalvanic cell of Comparative Example 4 was completed by changing the composition of the first electrode (low-temperature electrode) and the second electrode (high-temperature electrode) to Pt and also, changing the electrolyte of Example 1 to 1 M NaClO₄ in EC:DEC=3:7 (v:v).

### Evaluation Example: Output Voltage and Thermopower According to Temperature Change of Second Electrode (High-Temperature Electrode)

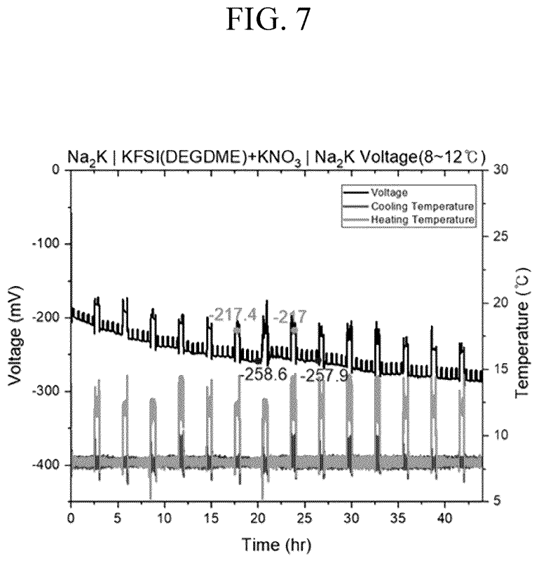

Each of thermogalvanic cells of the examples were evaluated with respect to output voltage over time by changing a temperature of the second electrode (high-temperature electrode) from 8° C. to 12° C., while a temperature of the first electrode (low-temperature electrode) was maintained at 8° C. The evaluation results are shown in FIG. 7.

The results of FIG. 7 are used to calculate thermopower (α) according to α=dV/dT, wherein the thermogalvanic cell of Example 1 exhibited thermopower (α) of 10.3 mV/K when the temperature of the second electrode (high-temperature electrode) was changed from 8° C. to 12° C., while the temperature of the first electrode (low-temperature electrode) was maintained at 8° C.

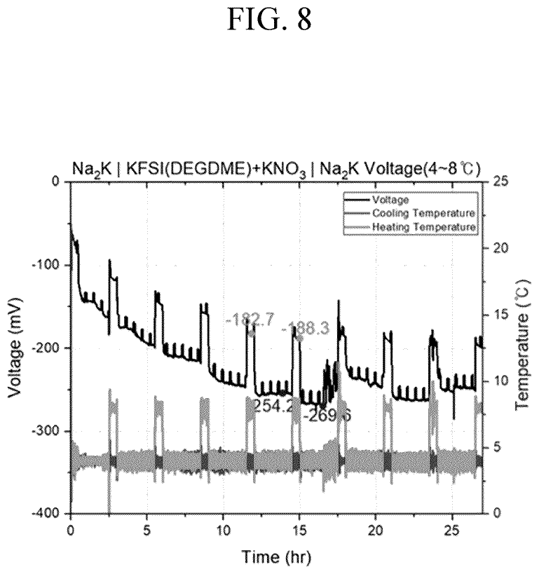

On the other hand, each of the thermogalvanic cells of the examples was evaluated with respect to output voltage over time by changing the temperature of the second electrode (high-temperature electrode) from 4° C. to 8° C., while the temperature of the first electrode (low-temperature electrode) was maintained at 4° C. The evaluation results are shown in FIG. 8.

The results of FIG. 8 are used to calculate thermopower (α) according to α=dV/dT, wherein the thermogalvanic cell of Example 1 exhibited thermopower (α) of 20.3 mV/K, when the temperature of the second electrode (high-temperature electrode) was changed from 4° C. to 8° C., while the temperature of the first electrode (low-temperature electrode) was maintained at 4° C.

Furthermore, each of the thermogalvanic cells of Examples 1 to 3 and Comparative Examples 1 to 3 was measured with respect to thermopower (α) according to α=dV/dT by changing the temperature of the second electrode (high-temperature electrode), while fixing the temperature of the first electrode (low-temperature electrode), and the results are shown in Table 1.

TABLE 1

| | First | | Second | | |
|---|---|---|---|---|---|
| | electrode | Electrolyte | electrode | α1 | α2 |
| Example 1 | Na₂₊ₓK | KPF₆ in | Na₂₊ₓK | 26.1 @ | — |
| | | DEGDME + | | (4→14° C.) | |
| | | TTE | | | |
| Example 2 | Na₂₊ₓK | KFSI + KNO₃ | Na₂₊ₓK | 20.3 @ | 10.3 @ |
| | | in DEGDME | | (4→8° C.) | (8→12° C.) |
| Example 3 | Na₂K | KFSI in | Na₂₊ₓK | 8.0 @ | 6.5 @ |
| | | DEGDME | | (4→8° C.) | (8→12° C.) |
| Example 4 | Na₂K | KPF₆ in | Na₂₊ₓK | 5.8 @ | 0.9 @ |
| | | EC + DEC | | (6→7° C.) | (7→8° C.) |
| Comparative | Na | NaClO₄ in | Na | 1.2 @ | — |
| Example 1 | | EC + DEC | | (30→50° C.) | |
| Comparative | K | KPF₆ in | K | 0.7 @ | — |
| Example 2 | | EC + DEC | | (50→60° C.) | |
| Comparative | Na_{0.7}K_{0.3} | NaClO₄ in | Na_{0.7}K_{0.3} | 0.55 @ | — |
| Example 3 | | EC + DEC | | (30→50° C.) | |

Referring to Table 1, when the temperature of the second electrode (high-temperature electrode) was the same, Examples 1, 2, and 3 exhibited significantly higher thermopower (α) of than that of Comparative Examples 1 to 3.

Comparative Examples 1 and 2, in which pure Na and K substances used rather than Na—K alloys had difficulties in operating the thermionic electronic cells within a temperature range passing each melting point, were understood to exhibit low thermopower (α). In Comparative Example 3, the thermogalvanic cell used an Na-based electrolyte, which still uses a Na₂₊ₓK-based alloy but in which phase transitions continuously occur over a wide temperature range, had low thermopower (α).

On the other hand, even when the Na₂₊ₓK-based alloy is applied as a symmetrical structure, thermopower (α) may be changed according to a temperature change of the second electrode (high-temperature electrode).

In particular, because the Na₂₊ₓK-based alloy has a melting point of about 7° C., it is desirable to change the second electrode from a temperature range below the melting point of the Na₂₊ₓK-based alloy to a temperature range beyond the melting point (e.g., change from 4° C. to 14° C.), while the first electrode is maintained within the temperature range (e.g., 4° C.) below the melting point of the Na₂₊ₓK-based alloy.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A thermogalvanic cell, comprising
a first electrode;
a second electrode; and
an electrolyte between the first electrode and the second electrode;
wherein the first electrode and the second electrode, identically or differently, include an alloy represented by Chemical Formula 1; and
power output is generated by an electrochemical reaction due to a temperature difference between the first electrode and the second electrode:

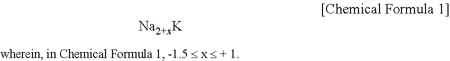

2. The thermogalvanic cell of claim 1, wherein
when the electrochemical reaction occurs, a temperature of the first electrode is maintained within a range of less than 7° C.

3. The thermogalvanic cell of claim 1, wherein
when the electrochemical reaction occurs, a temperature of the second electrode changes from a range of less than or equal to 8° C. to a range of less than or equal to 15° C.

4. The thermogalvanic cell of claim 1, wherein
a temperature difference between the first electrode and the second electrode is due to the first electrode being maintained in a solid state while only the second electrode undergoes a solid-liquid phase transition.

5. The thermogalvanic cell of claim 1, wherein
the electrolyte includes a potassium salt and a non-aqueous organic solvent.

6. The thermogalvanic cell of claim 5, wherein
the potassium salt includes at least one selected from,
a first potassium salt including K(FSO₂)₂N(KFSI), K(CF₃SO₂)₂N(KTFSI), KPF₆, KBF₄, KClO₄, KCF₃SO₃, KC₄F₉SO₃, KAsF₆, and KN(C₂F₅SO₂)₂ (KBETI); and
a second potassium salt including KNO₃, and KPO₂F₂.

7. The thermogalvanic cell of claim 5, wherein
the non-aqueous organic solvent includes at least one selected from,
a glyme-based solvent including ethylene glycol dimethylether (CH₃OCH₂CH₂OCH₃: monoglyme), and diethylene glycol dimethylether (CH₃ (OCH₂CH₂)₂OCH₃: diglyme); and
a carbonate-based solvent including dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), and propylene carbonate (PC), and butylene carbonate (BC).

8. The thermogalvanic cell of claim 5, wherein
the electrolyte further includes an additive, and
the additive includes TTE (1,1,2,2-tetrafluoroethyl-2,2,3,3-tetrafluoropropyl ether), C₃H₂O₃ (vinylene carbonate), C₃H₃FO₃ (fluoroethylene carbonate), or a combination thereof.

9. The thermogalvanic cell of claim 8, wherein
the additive is included in an amount of 0.1 to 10 wt % based on 100 wt % of the total amount of the electrolyte.

10. The thermogalvanic cell of claim 1, wherein
the second electrode further includes a porous substrate, and
an alloy represented by Chemical Formula 1 is impregnated into the interior of the porous substrate.

11. The thermogalvanic cell of claim 10, wherein
the porous substrate includes at least one selected from,
a metal foam including a copper foam; and
a porous carbon material including carbon paper, carbon cloth, and carbon felt.

12. The thermogalvanic cell of claim 1, wherein
the thermogalvanic cell further includes a porous separator, and
the electrolyte is impregnated inside a porous separator.

13. The thermogalvanic cell of claim 12, wherein
the separator is a glass filter, a porous polymer film, or an ion exchange film.

14. The thermogalvanic cell of claim 1, wherein
a thickness ratio of the first electrode and the second electrode is 1:2 to 2:1.

15. The thermogalvanic cell of claim 1, wherein
a thickness ratio of the first electrode and the electrolyte is 1:1 to 250:1.

16. The thermogalvanic cell of claim 1, wherein
a total thickness of the thermogalvanic cell is 0.1 to 5 cm.

17. The thermogalvanic cell of claim 1, wherein
a cooling source is disposed on the outside of the first electrode;
a heat source is disposed on the outside of the second electrode.
